(19) United States
(12) Patent Application Publication
(10) Pub. No.: US 2026/0126523 A1
(43) Pub. Date: May 7, 2026

(54) COMPUTING DEVICE AND METHOD FOR MONITORING A PERSON BASED ON RADAR SENSOR DATA

(71) Applicant: TECHNOLOGIES LIVINGSAFE INC, SAINTE-ANNE-DE-BELLEVUE (CA)

(72) Inventors: Justin ROCHEFORT, MONTREAL (CA); Joseph EL ACHKAR, PIERREFONDS-ROXBORO (CA); Louis LE GUERRIER, MONTREAL (CA)

(73) Assignee: TECHNOLOGIES LIVINGSAFE INC, SAINTE-ANNE-DE-BELLEVUE, QC (CA)

(21) Appl. No.: 19/116,469

(22) PCT Filed: Sep. 29, 2023
(86) PCT No.: PCT/CA2023/051295

§ 371 Date: Mar. 28, 2025

Related U.S. Application Data
(60) Provisional application No. 63/378,080, filed on Oct. 2, 2022.

(51) Int. Cl. G01S 7/41; G08B 21/04

(52) U.S. Cl. CPC G01S 7/417; G08B 21/043

(57) ABSTRACT

Monitoring device and method for monitoring a person based on radar sensor data. The monitoring device stores a predictive model of a neural network. The monitoring device collects sensor data representative of the person generated by the radar sensor, the sensor data comprising at least one of the following: a plurality of consecutive sets of centroid data representative of the person and a plurality of consecutive sets of point cloud data representative of the person. The monitoring device executes a neural network inference engine, implementing the neural network which uses the predictive model for inferring output(s) based on inputs. The one or more outputs provide an indication of whether an event related to the person has occurred or not. The inputs comprise at least some of the sensor data. Upon detection of the occurrence of the event, an alert message may be sent to a remote computing device.

### TECHNICAL FIELD

The present disclosure relates to the field of elder care monitoring. More specifically, the present disclosure relates to a computing device and method for monitoring a person based on radar sensor data.

### BACKGROUND

The part of the population consisting of elders requiring dedicated care services is steadily increasing. One important aspect of these care services comprises monitoring the activity of elders, to detect situations where assistance is needed. For example, providing the capability to detect the fall of an elder in (substantially) real time allows an early intervention of a care provider, which in turn prevents potential damaging consequences for the health of the elder.

Various types of monitoring systems have been developed and deployed, either at home for example for elders who still have the capability to live at home, or in dedicated facilities for elders who have lost the autonomy required for living in at home.

One example of monitoring system is a portable device carried by a person. The portable device comprises one or more sensor (e.g., a gyroscope, an accelerometer, etc.) to monitor the movements of a person wearing the portable device and to detect pre-defined events like a fall. Upon detection of a pre-defined event (e.g., a fall), an alert is transmitted to a care provider who can provide adequate assistance to the elder in a reasonable delay. One drawback with such portable devices is that the detection of a pre-defined event (e.g., a fall) is subject to an important rate of false positives (e.g., detection of a fall when in reality a fall did not occur).

Another example of monitoring system is based on the deployment of cameras and/or microphones, combined with sophisticated processing algorithms making use of artificial intelligence for detecting pre-defined events. However, this type of monitoring system raises issues with respect to the privacy of the monitored subjects.

Therefore, there is a need for a new computing device and method for monitoring a person based on radar sensor data.

### SUMMARY

According to a first aspect, the present disclosure relates to a monitoring device comprising memory, and a processing unit comprising one or more processor. The memory stores a predictive model of a neural network, the predictive model comprising weights of the neural network. The processing unit is configured to receive sensor data representative of a person, the sensor data being generated by a radar sensor. The sensor data comprise at least one of the following: a plurality of consecutive sets of centroid data representative of the person and a plurality of consecutive sets of point cloud data representative of the person. The processing unit is further configured to execute a neural network inference engine, the neural network inference engine implementing the neural network using the predictive model for inferring one or more output based on inputs. The one or more output provides an indication of whether an event related to the person has occurred or not. The inputs comprise at least some of the sensor data.

According to a second aspect, the present disclosure relates to a method for monitoring a person based on radar sensor data. The method comprises storing in a memory of a computing device a predictive model of a neural network, the predictive model comprising weights of the neural network. The method comprises collecting by a processing unit of the computing device sensor data generated by a radar sensor, the sensor data being representative of a person. The sensor data comprise at least one of the following: a plurality of consecutive sets of centroid data representative of the person and a plurality of consecutive sets of point cloud data representative of the person. The method comprises executing by the processing unit of the computing device a neural network inference engine, the neural network inference engine implementing the neural network using the predictive model for inferring one or more output based on inputs. The one or more output provides an indication of whether an event related to the person has occurred or not. The inputs comprise at least some of the sensor data.

In a particular aspect, the radar sensor is integrated to the monitoring device.

In another particular aspect, the radar sensor is not integrated to the monitoring device. The sensor data are received from the radar sensor via a communication interface of the monitoring device.

In still another particular aspect, the inputs comprise the plurality of consecutive sets of centroid data representative of the person, each set of centroid data comprising at least one of the following: at least one coordinate of the centroid, at least one velocity component of the centroid, and at least one acceleration component of the centroid.

In yet another particular aspect, the inputs comprise the plurality of consecutive sets of point cloud data representative of the person, each set of point cloud data comprising for each point of the point cloud at least one of the following: at least one coordinate of the point, a velocity of the point, and a signal to noise ratio (SNR) of the point.

In another particular aspect, the inputs further comprise at least one of the following: contextual information related to the person, contextual information related to an environment where the person is located, timing information and static coordinate data related to the environment where the person is located.

In still another particular aspect, the one or more output providing an indication of whether an event related to the person has occurred or not comprises at least one of the following: a Boolean and a probability. In a particular embodiment, the one or more output further comprises an indication of severity of the event.

In yet another aspect, the person is located in a room at least partially in a field of view of the radar sensor, and the event is a fall of the person.

In another aspect, the one or more output is indicative of the event related to the person having occurred, and the monitoring device performs at least one of the following actions: sending an alert message indicative of the event related to the person having occurred to a remote computing device and triggering a display of a visual indicator representative of the detection that the event related to the person has occurred. In a particular embodiment, the alert message comprises at least one of the following: a location where the event related to the person has occurred, the plurality of consecutive sets of centroid data representative of the person and the plurality of consecutive sets of point cloud data representative of the person.

### BRIEF DESCRIPTION OF THE DRAWINGS

Embodiments of the disclosure will be described by way of example only with reference to the accompanying drawings, in which:

FIG. 1 represents an environment where monitoring devices comprising a radar sensor are deployed;

FIG. 2 represents the environment of FIG. 1 with a person located in the environment;

FIG. 3 represents a virtual representation of the person in the environment of FIG. 2 generated by the radar sensor;

FIG. 4 represents the environment of FIG. 1 where monitoring devices and standalone radar sensors are deployed;

FIG. 5 represents a plurality of environments being simultaneously monitored by the monitoring devices of FIG. 1 or FIG. 4;

FIGS. 6A, 6B and 6C represent various implementations of the monitoring device and radar sensor;

FIG. 7 represents the interactions of a plurality of monitoring devices with a centralized monitoring server;

FIG. 8 represents a neural network inference engine executed by the monitoring device of FIGS. 6A, 6B and 6C for detecting the occurrence of an event related to a person;

FIG. 9 represents a neural network implemented by the neural network inference engine of FIG. 8; and

FIG. 10 represents a method implemented by the monitoring devices of FIGS. 6A, 6B and 6C for detecting the occurrence of the event related to the person, using the neural network inference engine of FIG. 8.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to elder care monitoring. A radar sensor is deployed in a living environment of a person (e.g., an elder living in an elder care facility with a bedroom and a bathroom). Sensor data collected by the radar sensor are analyzed to determine if a particular type of event (e.g., a fall) has occurred. The determination is made using machine learning techniques (e.g., with a neural network).

### Monitoring Device Using Radar Sensor Data

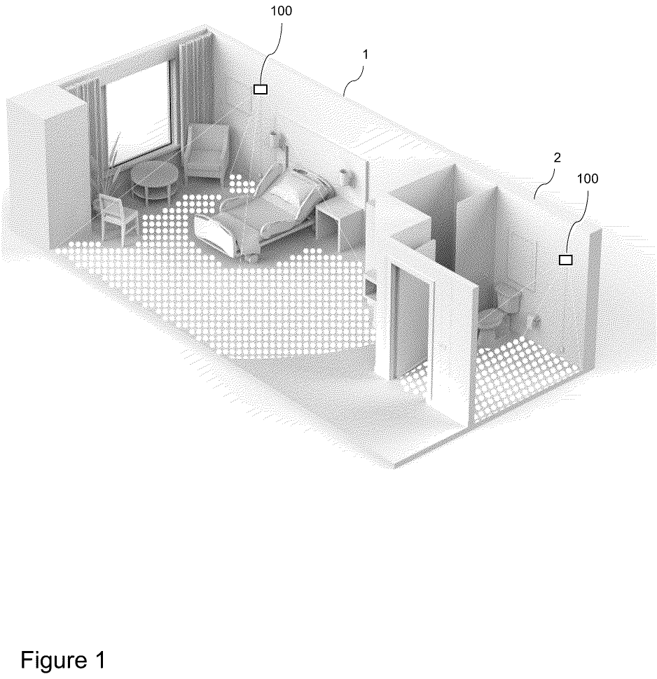

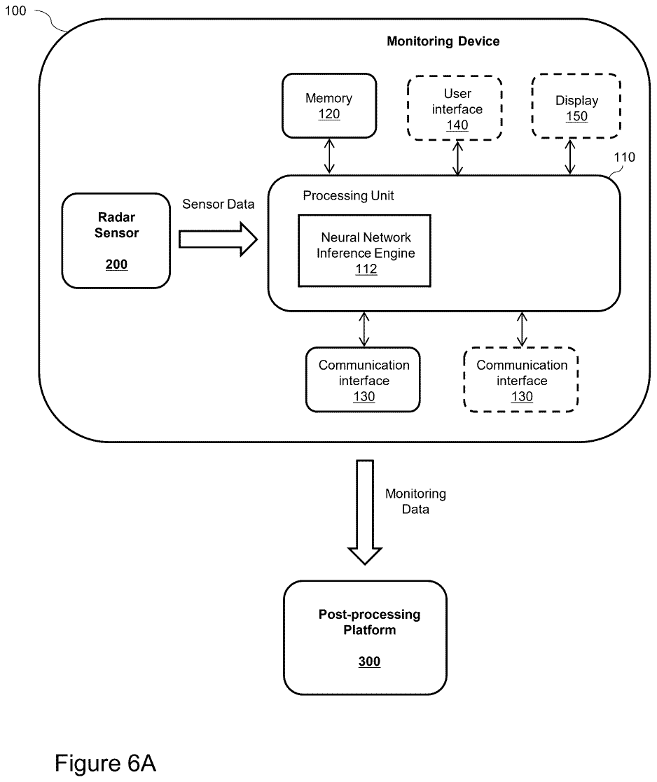

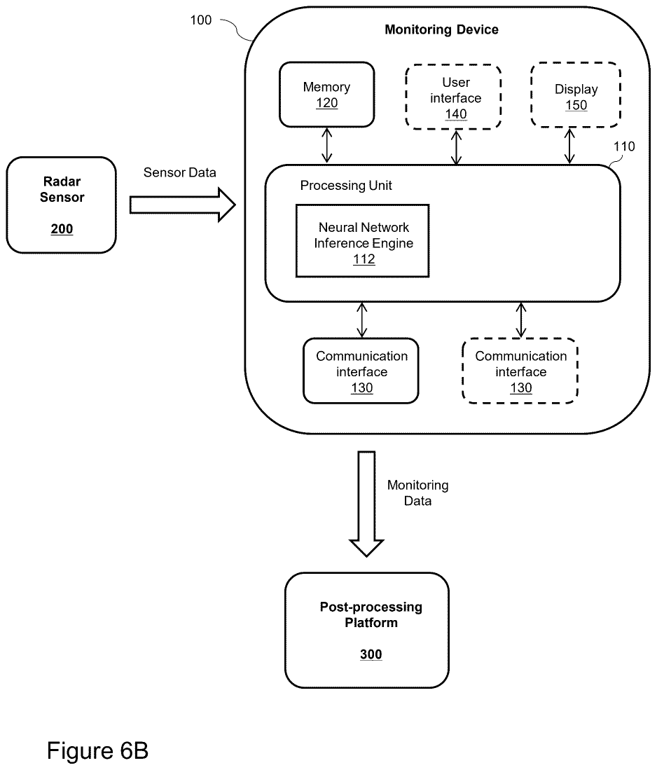

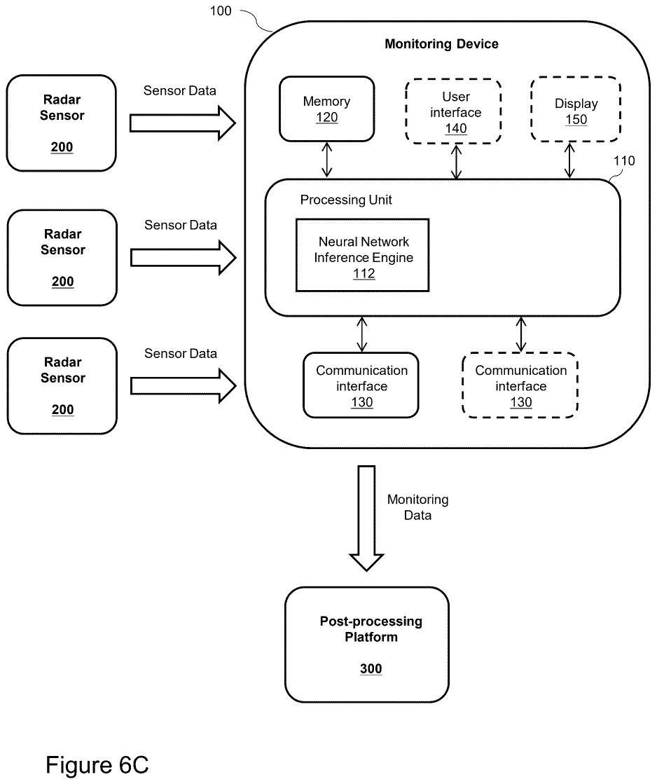

Reference is now made concurrently to FIGS. 1, 2, 3 and 6A. FIGS. 1, 2 and 3 represent an exemplary living environment for elders comprising two rooms: a bedroom 1 and a bathroom 2. A monitoring device 100 is located in each room. An exemplary implementation of the monitoring device 100 is represented in FIG. 6A. The monitoring device 100 comprises a radar sensor 200 capable of generating sensor data and a processing unit 110 capable of processing the sensor data to generate monitoring data. The position of the first monitoring device 100 (on a wall) in room 1 is determined to provide an optimal coverage of room 1 by the radar sensor 200 (not represented in FIGS. 1, 2 and 3 for simplification purposes) of the first monitoring device 100. Similarly, the position of the second monitoring device 100 (on a wall) in room 2 is determined to provide an optimal coverage of room 2 by the radar sensor 200 (not represented in FIGS. 1, 2 and 3 for simplification purposes) of the second monitoring device 100.

A radar sensor can detect various types of shapes: persons, animals, furniture, devices, etc. The present disclosure focuses on the monitoring of events associated to persons. Therefore, the radar sensor 200 is configured to specifically detect persons.

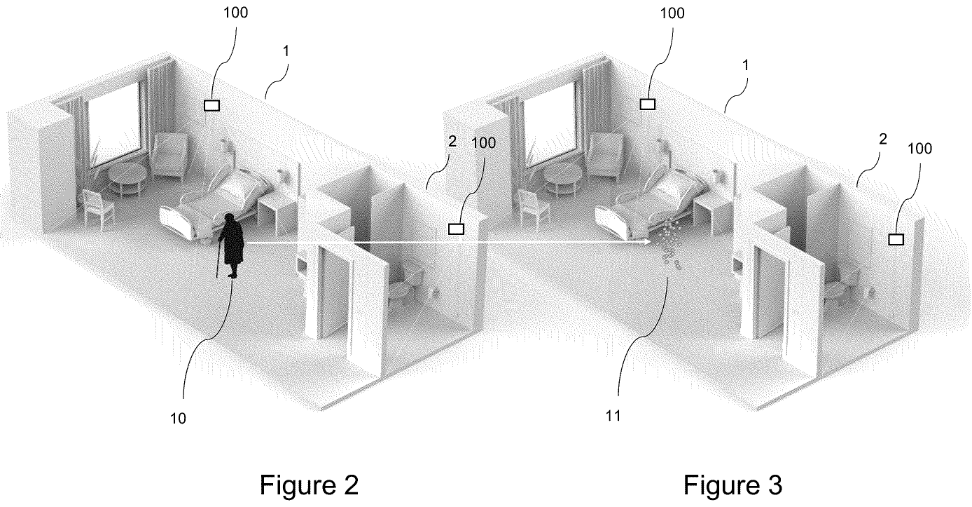

FIG. 2 corresponds to the environment of FIG. 1 with a person 10 located in room 1. FIG. 3 illustrates a virtual representation 11 of the person 10 generated by the radar sensor of the monitoring device 100 located in room 1. The virtual representation 11 consists of a point cloud representation comprising a number N of points representative of the person 10. Each point has coordinates in a 3D coordinate system. In the rest of the description, the 3D coordinate system will be a 3D cartesian coordinate system. Each point of the point cloud representation has coordinates x, y and z along corresponding respective X-axis, Y-axis, and Z-axis; where the Z-axis is a vertical axis and the three axes X, Y and Z are respectively orthogonal to each other. The coordinates of the points may be represented in a different 3D coordinate system, such as a 3D polar coordinate system (also referred to as a spherical coordinate system). A person skilled in the art would readily adapt the teachings of the present disclosure (as described with reference to a 3D cartesian coordinate system) to a 3D polar coordinate system. In general, the radar sensor of the monitoring device 100 generates point coordinates in a 3D polar coordinate system, which are internally converted into a 3D cartesian coordinate system. Thus, the processing unit 110 of the monitoring device 100 receives 3D cartesian coordinates from the radar sensor 200. If the processing unit 110 of the monitoring device 100 receives 3D polar coordinates from the radar sensor 200, the received coordinates are either used directly by the processing unit 110 to generate the monitoring data or converted into 3D cartesian coordinates by the processing unit 110 to generate the monitoring data.

The radar sensor 200 is capable of generating in (substantially) real time consecutive sets of data (a temporal sequence of data sets) representative of a person (e.g., person 10) located in an environment (e.g., room 1) under the control of the monitoring device 100 comprising the radar sensor 200. The environment (e.g., room 1) is at least partially in a field of view of the radar sensor 200. Each set of data is representative of the position, movement, posture, etc. of the person 10 at an instant t. Thus, a plurality of consecutive sets of data may be representative of the person moving in a given direction, the person standing still (horizontally, vertically, sitting, etc.), the person performing an irregular movement (e.g., a fall), etc. The sensor data illustrated in FIG. 6A represent the flow of consecutive sets of data transmitted by the radar sensor 200 to the processing unit 110.

A set of data representative of a monitored person comprises at least some of the following data: 3D coordinates for each of the N points representative of the person as defined by the aforementioned point cloud representation, a velocity for each of the N points (calculated by the radar sensor 200 using the Doppler effect as is well known in the art), a signal to noise ratio (SNR) for each of N the points (representative of how the current point differentiates from the noise level of its surroundings), 3D coordinates of a centroid representative of the person, velocity of the centroid, and acceleration of the centroid. The centroid is a single reference point representative of the person (which is complementary to the N points of the point cloud). The 3D coordinates of the centroid are determined by the radar sensor 200, by applying a dedicated algorithm which is out of the scope of the present disclosure (for example, by using a predictive model based on a Kalman Filter). The velocity and acceleration of the centroid (which are also determined by the radar sensor 200 by applying a dedicated algorithm) generally respectively consist of a triplet. For example, in a 3D cartesian coordinate system, the velocity and acceleration of the centroid respectively have a component along the X-axis, a component along the Y-axis and a component along the Z-axis. Each set of data may include additional data associated to the monitored person, such as a timestamp associated to each set of data.

The rate at which the sets of data are generated depends on the capabilities of the radar sensor. For example, the rate is 10 sets of data per second. The rate may be configurable, with potentially a degradation of the amount of information available per set of data when the rate increases. The type of information included in each set of data may also be configurable. Alternatively, if the radar sensor 200 generates information which are sent by default and are not used by the monitoring device 100, they can be filtered (e.g. dropped) by the processing unit 110 to only take into consideration useful information.

Referring more specifically to FIG. 6A, the monitoring device 100 comprises the radar sensor 200, the processing unit 110, memory 120, a communication interface 130, optionally a user interface 140, and optionally a display 150. The platform 100 may comprise additional components not represented in FIG. 6A for simplification purposes (e.g. an additional communication interface 130).

The components of the radar sensor 200 will not be described in detail since the precise implementation of the radar sensor 200 is out of the scope of the present disclosure. The radar sensor 200 usually comprises one or more sensing component generating raw sensor data. The radar sensor 200 usually also comprises a processing unit (e.g., one or more processor, one or more field-programmable gate array (FPGA), one or more application-specific integrated circuit (ASIC), a combination thereof, etc.) for processing the raw sensor data to generate the sensor data transmitted to the processing unit 110. The radar sensor 200 usually also comprises a data transmission interface (e.g., an interface to an internal bus of the monitoring device 100 (not represented in FIG. 6A), the processing unit 110 being also connected to the internal bus) for transferring the sensor data to the processing unit 110.

The processing unit 110 comprises one or more processor (not represented in FIG. 6A) capable of executing instructions of a computer program. Each processor may further comprise one or several cores. Alternatively, or complementarily, the processing unit 110 comprises one or more FPGA, one or more ASIC, etc.

The memory 120 stores instructions of computer program(s) executed by the processing unit 110, data generated by the execution of the computer program(s), sensor data received from the radar sensor 200, data received via the communication interface 130, etc. Only a single memory 120 is represented in FIG. 6A, but the monitoring device 100 may comprise several types of memories, including volatile memory (such as a volatile Random Access Memory (RAM), etc.) and non-volatile memory (such as a hard drive, solid-state drive (SSD), electrically erasable programmable read-only memory (EEPROM), flash, etc.).

Each communication interface 130 allows the monitoring device 100 to exchange data with other devices (e.g., a post-processing platform 300 which will be described alter, etc.) over one or more communication network (not represented in FIG. 6A for simplification purposes). The term communication interface 130 shall be interpreted broadly, as supporting a single communication standard/technology, or a plurality of communication standards/technologies. Examples of communication interfaces 130 include a wireless (e.g., Wi-Fi, Bluetooth®, Bluetooth Low Energy (BLE), cellular, wireless mesh, etc.) communication module, a wired (e.g., Ethernet) communication module, a combination of wireless and wired communication modules, etc. The communication interface 130 usually comprises a combination of hardware and software executed by the hardware, for implementing the communication functionalities of the communication interface 130.

Reference is now made concurrently to FIGS. 3, 4, 6A and 6B. FIG. 6B represents another implementation of the monitoring device 100. The monitoring device 100 illustrated in FIG. 6B is similar to the monitoring device 100 illustrated in FIG. 6A, except for the radar sensor 200 not being integrated to the monitoring device 100 but operating as a standalone sensor.

The radar sensor 200 comprises a communication interface (not represented in FIG. 6B). The sensor data are transmitted by the radar sensor 200 via its communication interface and received by (one of) the communication interface(s) 130 of the monitoring device 100. In an exemplary configuration, the monitoring device 100 has a single communication interface 130 for exchanging data with the radar sensor 200 and the post-processing platform 300. Alternatively, the monitoring device 100 has a first communication interface 130 dedicated to the exchange of data with the radar sensor 200 and a second communication interface 130 dedicated to the exchange of data with the post-processing platform 300. The exchange of data (e.g., the sensor data) between the radar sensor 200 and the monitoring device 100 is generally based on a wireless communication standard (e.g., Wi-Fi, Bluetooth, BLE, etc.). However, a wired communication standard may be used alternatively.

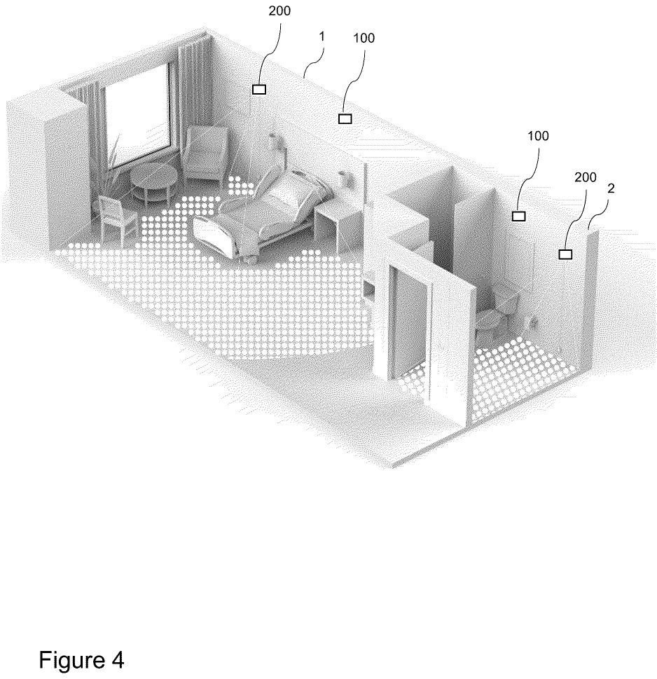

FIG. 4 illustrate a configuration where, instead of deploying a monitoring device 100 comprising an integrated radar sensor 200 (as illustrated in FIG. 1) in each room (e.g., 1 and 2), a standalone radar sensor 200 and a monitoring device 100 (as illustrated in FIG. 4) are deployed in each room (e.g., 1 and 2). As mentioned previously, a position of the radar sensor 200 (on a wall) in the respective rooms (e.g., 1 and 2) is determined to provide an optimal coverage of the respective rooms by the radar sensor 200. By contrast, a position of the monitoring device 100 in the respective rooms is generally not subject to positioning constraints. However, if the monitoring device 100 comprises a user interface 140 and/or a display 150, the position of the monitoring device 100 may have positioning constraint with respect to accessibility and/or visibility by a person located in the corresponding room.

In this configuration, each monitoring device 100 is associated to a single radar sensor 200 and receives (radar) sensor data only from this radar sensor 200.

Reference is now made concurrently to FIGS. 3, 4, 6B and 6C. FIG. 6C represents another implementation of the monitoring device 100. The monitoring device 100 illustrated in FIG. 6C is similar to the monitoring device 100 illustrated in FIG. 6B, except for the monitoring device being adapted to receive and process sensor data from a plurality of radar sensors 200. Consequently, the processing power of the processing unit 110 and/or the capacity of the memory 120 of the monitoring device 100 of FIG. 6C may be superior to those of the monitoring device 100 of FIG. 6B. Additionally, software programs executed by the processing unit 110 are capable to independently process the sensor data received from the respective different radar sensors 200.

Referring to FIG. 4, instead of having a monitoring device 100 deployed in each room 1 and 2, a single monitoring device 100 is deployed in one of the rooms (e.g. 1) and receives sensor data from the two radar sensors 200 deployed in each room 1 and 2. In another configuration, a single monitoring device 100 is used for controlling a plurality of units (each unit comprising rooms 1 and 2) similar to the one illustrated in FIG. 4. The monitoring device 100 is deployed in one of the units under its control (or in another location) and receives sensor data from the radar sensors 200 deployed in each room of the units under its control.

In still another configuration, referring to FIG. 1, a monitoring device 100 with an integrated radar sensor 200 (as illustrated in FIG. 6A) is deployed in one of the rooms (e.g., 1) and a standalone radar sensor 200 is deployed in the other room (e.g., 2). The monitoring device 100 receives and processes the sensor data from its integrated radar sensor 200 and from the standalone radar sensor 200.

### Processing of the Sensor Data by a Neural Network

The neural network technology relies on the collection of a large quantity of data during a training phase, which are used for training a neural network. The result of the training phase is a predictive model generated by the neural network. Then, during an operational phase, the neural network uses the predictive model to generate predicted output(s) based on inputs.

Although the rest of the disclosure is based on the usage of a neural network, a person skilled in the art would readily understand that other machine learning technologies may be used in place of a neural network. The neural network is used to determine if a particular type of event related to a person has occurred or not (e.g., a fall), using at least some of the sensor data generated by the radar sensor 200.

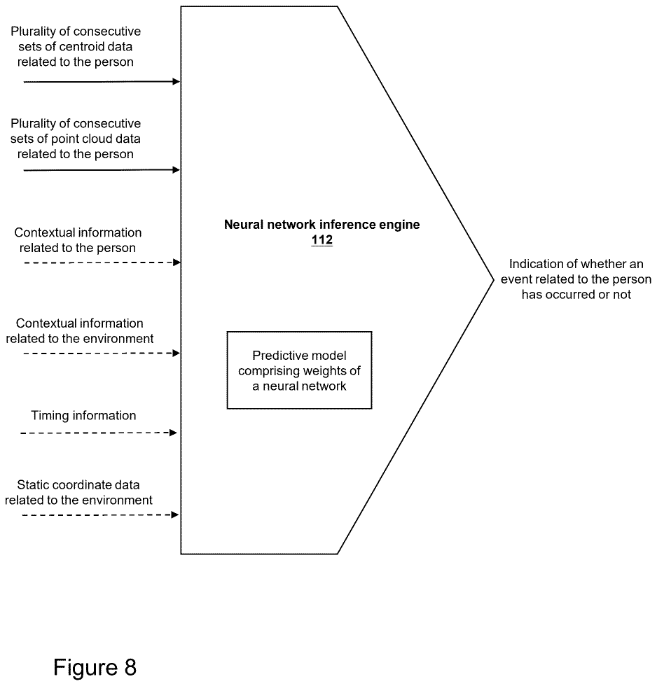

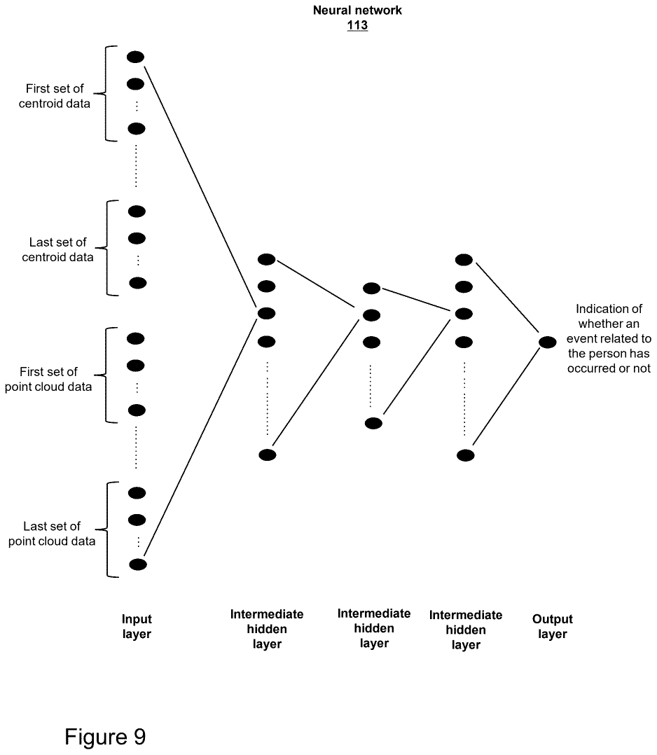

Reference is now made concurrently to FIGS. 6A-C, 8 and 9. FIG. 8 is a schematic representation of the neural network inference engine 112 executed by the processing unit 110 of the monitoring device 100, with its inputs and its output(s). FIG. 9 provides a detailed representation of a neural network 113 implemented by the neural network inference engine 112.

The inputs received by the neural network inference engine 112 comprise at least some of the sensor data received by the processing unit 110 from the radar sensor 200. The sensor data are associated to and representative of a person whose activity in an environment is monitored. The environment is generally a room but can be generalized to any environment which can be monitored by a radar sensor. The present disclosure addresses a person, but can be generalized to other types of monitoring candidates, such as an animal, a moving object, etc.

A first example of inputs consists of a plurality of consecutive sets of centroid data representative of a person. Each set of centroid data comprises at least one of the following: at least one coordinate of the centroid, at least one velocity component of the centroid, and at least one acceleration component of the centroid. As described previously, the coordinates, the velocity components and the acceleration components are usually defined in a 3D coordinate system. For example, in a cartesian 3D coordinate system, the coordinates, velocity and acceleration respectively have three components defined with respect to the X-axis, Y-axis and Z-axis of a 3D cartesian coordinate system. Any combination of these components can be used as inputs.

A second example of inputs consists of a plurality of consecutive sets of point cloud data representative of the person. Each set of point cloud data comprises data related to a plurality of points of the point cloud. For each point of the point cloud, the point cloud data comprise at least one of the following: at least one coordinate of the point, a velocity of the point, a SNR of the point. As mentioned previously, point cloud data are provided by the radar sensor 200 for a point cloud comprising N points. In a first implementation, point cloud data for the N points of the point cloud are used as inputs. In a second implementation, point cloud data for only a sample of the N points of the point cloud are used as inputs. As mentioned with respect to the centroid data, the coordinates of each point are usually defined in a 3D coordinate system (e.g. a cartesian 3D coordinate system).

A third example of inputs consists of contextual information related to the person. Examples of contextual information related to the person include an history of positions of the person, an history of movements of the person, habits of the person, etc.

A fourth example of inputs consists of contextual information related to the environment where the person is located. Examples of contextual information related to an environment consisting of a room include a type of the room (e.g., bedroom, bathroom, etc.), a distance between walls of the room, etc.

A fifth example of inputs consists of timing information, such as for example a current time, a current period during the day (e.g. morning, afternoon, evening, night, etc.), a current day of the week, a combination thereof, etc.

A sixth example of inputs consists of static coordinate data related to the environment where the person is located, which are also collected by the radar sensor 200. The static coordinate data are representative of one or more static point located in the environment of the person. Examples of static point include a point located on a wall, a point located on an object (e.g. on a piece of furniture), etc. As mentioned previously, the static coordinate data are usually defined in a 3D coordinate system. As mentioned previously, for each static point, the corresponding static coordinate data may also include a SNR value.

Any combination of the previous four examples of inputs may be used as inputs. The plurality of consecutive sets of centroid data correspond to a temporal sequence of monitoring of the person. For example, if the sampling rate of the radar sensor 200 is 10 samples per second, 2 seconds of monitoring sequence generate 20 sets of centroid data used as inputs. Similarly, 2 seconds of monitoring generate 20 sets of point cloud data used as inputs

If the inputs comprise a plurality of consecutive sets of centroid data and a plurality of consecutive sets of point cloud data, their respective sampling rate may be the same or different. For example, referring to the previous example, the inputs include the 20 sets of centroid data (nominal sampling rate of 10 samples per second), but only 10 sets of point cloud data (sub-sampling rate of 5 samples per second).

FIGS. 8 and 9 illustrate an example of inputs received by the neural network inference engine 112, processed by the neural network 113, to generate predicted output(s). In this example, the inputs comprise a plurality of consecutive sets of centroid data representative of the person and a plurality of consecutive sets of point cloud data representative of the person. Optionally, the inputs also include at least one of the following: contextual information related to the person, contextual information related to the environment where the person is located, timing information and static coordinate data related to the environment where the person is located. The optional contextual information related to the person, contextual information related to the environment, timing information and static coordinate data related to the environment are not represented in FIG. 9 for simplification purposes.

With respect to the generated predicted output(s), the one or more output provides an indication of whether an event related to the person has occurred or not. One example of event consists of a fall of the person, where the person is located in an environment withing the field of view of the radar sensor 200 (e.g., a room as mentioned previously). However, the present disclosure is not limited to the detection of the fall of the person but can be applied to the detection of other events related to a person. In one exemplary implementation, the one or more output comprises a Boolean indicating whether the event related to the person has occurred or not. In another exemplary implementation, the one or more output comprises a probability of the event related to the person having occurred or not (e.g. a percentage of chances that the event has occurred or alternatively a percentage of chances that the event has not occurred). In still another exemplary implementation, the one or more output comprises both the Boolean (indicating whether the event related to the person has occurred or not) and the probability (of the event related to the person having occurred or not). Optionally, the one or more output further comprises an indication of severity of the event (e.g. a Boolean indicating whether the event is severe or not, a set of discrete values representative of various levels of severity (e.g. benign, serious, critical, etc.), etc.). FIGS. 8 and 9 illustrate an example where there is only one output (e.g. a Boolean or a probability) indicative of whether the event related to the person has occurred or not.

The neural network 113 illustrated in FIG. 9 includes an input layer with a number of neurons adapted for receiving any of the combinations of inputs which have been previously described. Details of the information received by each neuron of the input layer are not represented in FIG. 9 for simplification purposes.

In an exemplary implementation, for each set of centroid data, the input layer comprises nine neurons for respectively receiving x, y and z coordinates of the centroid; x, y and z velocity components of the centroid; and x, y and z acceleration components of the centroid. For each set of point cloud data, and for each point within the point cloud, the input layer comprises 5 neurons for respectively receiving x, y and z coordinates of the point; the velocity of the point; and the SNR of the point. Thus, if the point cloud comprises 20 points, the input layer comprises 5*20=100 neurons per set of point cloud data.

The neural network includes an output layer with one or more neuron. FIG. 9 illustrates an exemplary implementation with a single neuron in the output layer for outputting an indication of whether an event related to the person has occurred or not. For example, the output neuron generates a Boolean value which is true if an event related to the person has occurred and false if an event related to the person has not occurred. In another example, the output neuron generates a probabilistic value indicative of an event related to the person having occurred (e.g. 75% of chances that an event related to the person has occurred).

The number of neurons of the input layer, the inputs, the number of neurons of the output layer and the outputs represented in FIG. 9 are for illustration purposes only, and can be adapted to support more or less inputs, other types of inputs, more or less outputs, and other types of outputs.

The neural network 113 includes three intermediate hidden layers between the input layer and the output layer. All the layers are fully connected. A layer L being fully connected means that each neuron of layer L receives inputs from every neurons of layer L-1, and applies respective weights to the received inputs. By default, the output layer is fully connected to the last hidden layer. The number of intermediate hidden layers is an integer greater or equal than 1 (FIG. 9 represents three intermediate hidden layers for illustration purposes only). The number of neurons in each intermediate hidden layer may vary. During the training phase of the neural network 113, the number of intermediate hidden layers and the number of neurons for each intermediate hidden layer are selected, and may be adapted experimentally. The generation of the outputs based on the inputs using weights allocated to the neurons of the neural network 113 is well known in the art. The architecture of the neural network, where each neuron of a layer (except for the first layer) is connected to all the neurons of the previous layer is also well known in the art.

The neural network 113 may also use convolution layer(s) and optionally pooling layer(s) following the convolution layer(s). The convolution layer(s) and pooling layer(s) are implemented between the input layer and the first intermediate layer. The final outputs generated by the convolution layer(s) and pooling layer(s) are used as inputs of the first intermediate hidden layer. For example, a convolution is applied to at least some of the data of the plurality of consecutive sets of centroid data. Similarly, a convolution is applied to at least some of the data of the plurality of consecutive sets of point cloud data. In another example, the plurality of consecutive sets of centroid data and the plurality of consecutive sets of point cloud data are combined to generate a plurality of consecutive sets of combined data. A convolution is applied to at least some of the data of the plurality of consecutive sets of combined data.

Following is a description of the training phase, which results in the generation of the predictive model of the neural network 113. During the training phase, a neural network training engine is trained with a plurality of inputs and a corresponding plurality of outputs. The types of inputs and outputs used during the training phase are the same as the types of inputs and outputs used during the operational phase.

The neural network training engine is executed by a processing unit of a dedicated training server (not represented in the Figures for simplifications purposes). Once the training is completed, the predictive model is transmitted to the monitoring device 100. The predictive model is received via the communication interface 130 and stored in the memory 120. During the operational phase, the predictive model stored in the memory 120 is used by the neural network inference engine 112 executed by the processing unit 110.

As is well known in the art of neural networks, during the training phase, the neural network 113 implemented by the neural network training engine 112 adjusts its weights. Furthermore, during the training phase, the number of layers of the neural network 113 and the number of nodes per layer can be adjusted to improve the accuracy of the model. At the end of the training phase, the predictive model generated by the neural network training engine includes the number of layers, the number of neurons per layer, and the weights.

Various techniques well known in the art of neural networks are used for performing (and improving) the generation of the predictive model, such as supervised and unsupervised learning, forward and backward propagation, usage of bias in addition to the weights (bias and weights are generally collectively referred to as weights in the neural network terminology), reinforcement learning, etc.

### Transmission of Monitoring Data

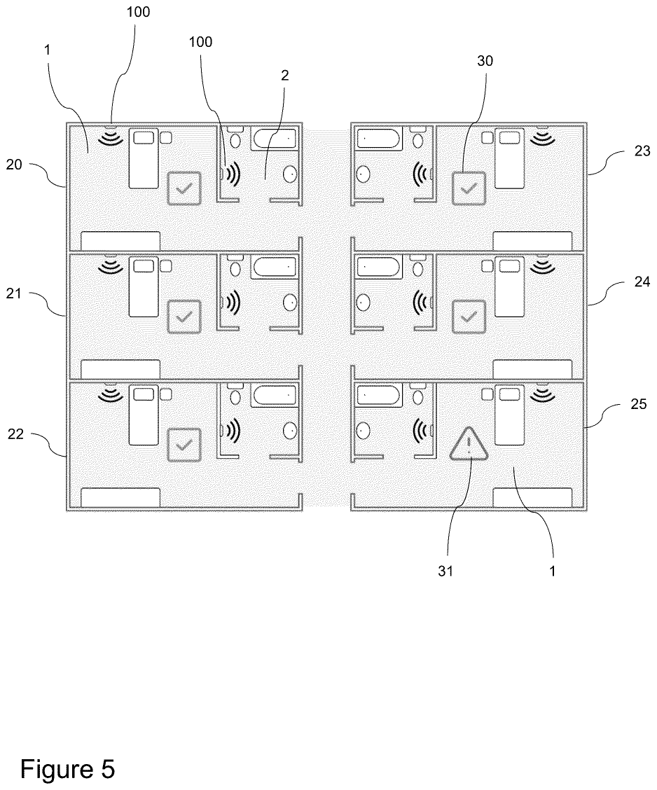

Reference is now made concurrently to FIGS. 5, 6A-C and 7. As illustrated in FIGS. 6A-C, the monitoring device 100 transmits monitoring data to a post-processing platform 300. The monitoring data are based on the processing of the sensor data received by the monitoring device 100 from the radar sensor(s). An example of monitoring data includes data generated and transmitted when an occurrence of an event is detected by the monitoring device 100. Another example of monitoring data includes at least some of the sensor data received by the monitoring device 100 from the radar sensor(s), which are transmitted to the post-processing platform 300 for archiving purposes. Although a single post-processing platform 300 is represented in FIGS. 6A-C, the monitoring device 100 may transmit monitoring data to a plurality of post-Processing processing platforms 300.

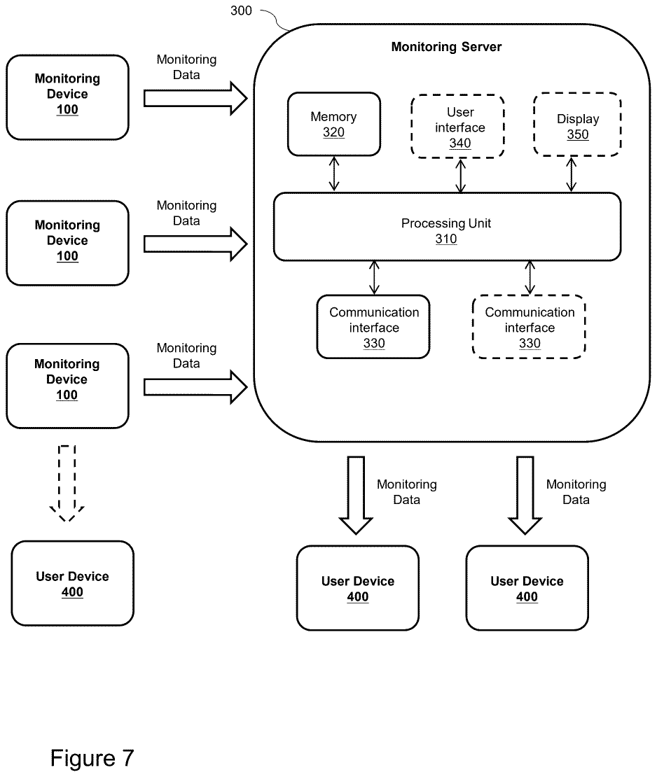

Referring to FIG. 7, an example of post-processing platform 300 consisting of a monitoring server is represented. The monitoring server 300 receives monitoring data from a plurality of monitoring devices 100. Although three monitoring devices 100 are illustrated in FIG. 7, the monitoring server 300 may receive and process monitoring data generated by any number of monitoring devices 100 (one or more).

The monitoring server 300 comprises a processing unit 310, memory 320, at least one communication interface 330, optionally a user interface 340, and optionally a display 350. Characteristics of the processing unit 310, memory 320, communication interface 330, user interface 340 and display 350 are similar to the previously described corresponding components of the monitoring devices 100.

Referring to FIGS. 5 and 7, FIG. 5 illustrates an exemplary configuration where the monitoring server 300 monitors six living environments 20, 21, 22, 23, 24 and 25. Each living environment corresponds to the living environment illustrated in FIG. 1, and comprises a bedroom 1 and a bathroom 2. For each living environment 20-25, a monitoring device 100 is deployed in the bedroom 1 and a monitoring device 100 is deployed in the bathroom 2. The monitoring devices 100 correspond to the implementation illustrated in FIG. 6A, where the radar sensor 200 is integrated to the monitoring device 100. Thus, the monitoring server 300 receives monitoring data from twelve monitoring devices 100.

In an exemplary implementation, FIG. 5 illustrates the information displayed on the display 350 of the monitoring server 300. If no alert is currently activated for a living environment, an icon 30 indicating that everything is normal is displayed in the representation of the living environment. For example, in FIG. 5, everything is normal in living environments 20-24. If an alert is currently activated for a living environment, an icon 31 indicating that something abnormal is occurring is displayed in the representation of the living environment. More specifically, the icon 31 is displayed in the room where the abnormal event is occurring. For example, in FIG. 5, an abnormal event is occurring in the bedroom 1 of living environment 25. An alert is activated upon reception of monitoring data from a monitoring device 100, where the monitoring data include an indication that an occurrence of an event has been detected by the monitoring device 100. The monitoring data further comprise information for identifying the room and living environment where the event has occurred. If the monitoring device 100 is capable of detecting different types of events, the monitoring data also comprise an identification of the type of event which has been detected. In this case, different icons 31 corresponding to the different types of events may be used for precisely identifying the type of event corresponding to an alert.

The monitoring server 300 may be implemented by any kind of computing device with sufficient capabilities for implementing the functionalities of the monitoring server 300 (e.g. a computer, a server, a tablet, a smartphone, etc.).

Optionally, as illustrated in FIG. 7, the monitoring server 300 is capable of forwarding monitoring data to one of more user device 400. The monitoring data transmitted to the user devices 400 are based on the monitoring data received from the monitoring devices 100. For example, all or a subset of the monitoring data received from the monitoring devices 100 are forwarded without changes to the user devices 400. Alternatively or complementarily, all or a subset of the monitoring data received from the monitoring devices 100 are processed before forwarding of the processed monitoring data to the user devices 400. Furthermore, a user device 400 may be allowed to receive monitoring data originating only from one or more pre-defined monitoring device 100, but not from all the monitoring devices 100. For example, referring to FIG. 5, a member of the family of a person living in environment 20 receives monitoring data on a personal user device (e.g. smartphone) originating only from monitoring devices 100 deployed in the bedroom 1 and the bathroom 2 of living environment 20. Additionally, as illustrated in FIG. 7, a monitoring device 100 may be configured to transmit monitoring data to a centralized monitoring server 300, and optionally also directly to one or more user device 400.

### Additional Functionalities of the Monitoring Device

Reference is now made concurrently to FIGS. 6A-C. One additional functionality is the capability by the monitoring device 100 to generate a visual indicator upon detection that an event (e.g. a fall) of the person has occurred. In an exemplary implementation, the monitoring device 100 comprises a component capable of generating a backlight signal. The backlight signal may be static, dynamic, or configurable. The backlight signal is for instance projected on a wall of the environment where the person is located (e.g. a wall of the bedroom), so that a person entering the environment immediately understands that an event has occurred by seeing the backlight signal. Alternatively, the component capable of generating the backlight signal is not integrated to the monitoring device 100, but connected to and controlled by the monitoring device 100. In another implementation where the monitoring device 100 comprises the display 150, the visual indicator representative of the detection that the event (e.g. a fall) related to the person has occurred is displayed on the display 150 of the monitoring device 100.

Another additional functionality is the capability by the monitoring device 100 to display vital signs of the person upon detection of the occurrence of a pre-defined event related to the person (e.g. person sitting or lying in a bed). Some radar sensors 200 have the capability to measure vital signs of a person within short range of the radar sensor 200. More specifically, based on chest movements of the person detected and processed by the radar sensor 200, vital signs such as the heartbeat and/or the breathing rate of the person are determined by the radar sensor 200. The vital signs determined by the radar sensor 200 are transmitted to the processing unit 110 of the monitoring device 100 and displayed on the display 150 of the monitoring device 100. Alternatively, the monitoring device 100 forwards the vital signs received from the radar sensor 200 to a nearby device, for display on a screen of the nearby device. The pre-defined event can be detected as described previously, using a neural network trained to provide an indication of whether an event related to the person has occurred or not. In this case, the event is for example the person sitting on the bed or lying on the bed.

### Method for Monitoring a Person Based on Radar Sensor Data

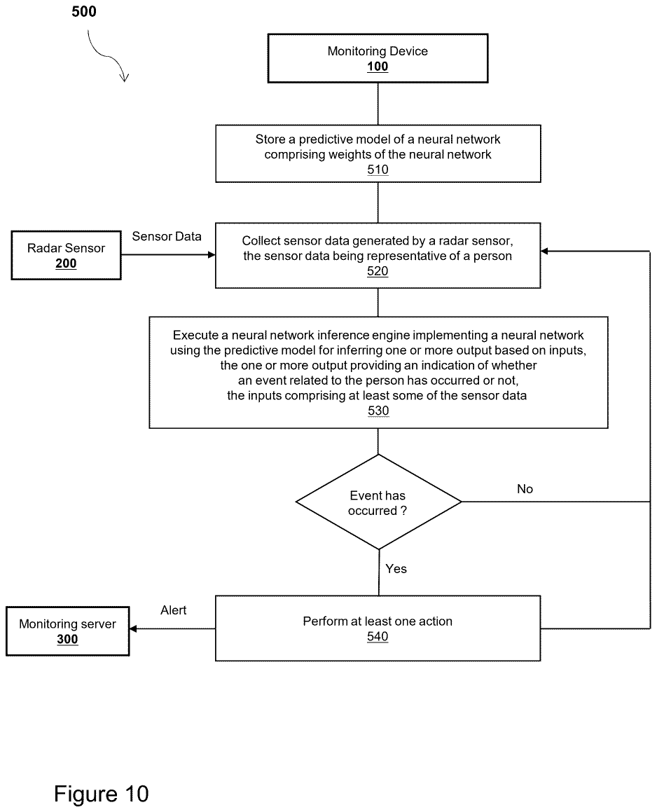

Reference is now made concurrently to FIGS. 6A-C, 8, 9 and 10, where FIG. 10 represents a method 500 for monitoring a person based on radar sensor data. At least some of the steps of the method 500 are implemented by the processing unit 110 of the monitoring device 100.

Furthermore, a dedicated computer program has instructions for implementing at least some of the steps of the method 500. The instructions are comprised in a non-transitory computer-readable medium (e.g. in the memory 120) of the computing device 100. The instructions, when executed by the processing unit 110, provide for monitoring a person based on radar sensor data. The instructions are deliverable to the monitoring device 100 via an electronically-readable media such as a storage media (e.g. any internally or externally attached storage device connected via USB, Firewire, SATA, etc.), or via communication links (e.g. via a communication network through the communication interface 130).

The method 500 comprises the step 510 of storing in the memory 120 of the computing device 100 the predictive model of the neural network 113. The predictive model comprises the weights of the neural network 113. As mentioned previously, the predictive model has been generated during the training phase by a neural network training engine, and transmitted to the computing device 100 for storage in the memory 120.

The method 500 comprises the step 520 of collecting sensor data generated by the radar sensor 200, the sensor data being representative of the person (monitored by the radar sensor 200). Step 520 is executed by the processing unit 110 of the monitoring device 100. FIG. 10 illustrates the configuration where the radar sensor 200 is not integrated to the monitoring device 100, according to FIGS. 6B and 6C. However, the method 500 also supports the configuration where the radar sensor 200 is integrated to the monitoring device 100, according to FIG. 6A. For example, the sensor data comprise at least one of the following: the plurality of consecutive sets of centroid data representative of the person and the plurality of consecutive sets of point cloud data representative of the person.

The method 500 comprises the step 530 of executing the neural network inference engine 112, the neural network inference engine 112 implementing the neural network 113 using the predictive model for inferring one or more output based on inputs. Step 530 is executed by the processing unit 110 of the monitoring device 100. As mentioned previously, the one or more output provides an indication of whether an event related to the person (monitored by the radar sensor 200) has occurred or not. The inputs comprise at least some of the sensor data collected at step 520. FIG. 9 illustrates an exemplary implementation where both the plurality of consecutive sets of centroid data and the plurality of consecutive sets of point cloud data are used as inputs of the neural network 113.

Following step 530, if the one or more output provides an indication that an event related to the person has not occurred, no action is taken and steps 520-530 are repeated.

Following step 530, if the one or more output provides an indication that an event related to the person has occurred, at least one action is performed as per step 540.

The method 500 comprises the step 540 of performing at least one action. Step 540 is executed by the processing unit 110 of the monitoring device 100. After performing the at least one action, steps 520-530 are repeated.

FIG. 10 illustrates an exemplary action performed at step 540, consisting of sending an alert message (indicative of the event related to the person having occurred) to the monitoring server 300. The alert message may further comprise monitoring data generated by the monitoring device 100, such as: the type of event having occurred if different types of events are monitored by the monitoring device 100, a location where the event as occurred (e.g. a room where a person has fallen), all or a subset of the sensor data used as inputs of the neural network 113 at step 530 (e.g. the plurality of consecutive sets of centroid data representative of the person and/or the plurality of consecutive sets of point cloud data representative of the person), metrics calculated by the monitoring device 100 based on the sensor data, etc.

As mentioned previously, another exemplary action performed at step 540 (not represented in FIG. 10) consists of triggering a display of a visual indicator representative of the detection that the event related to the person has occurred.

The monitoring device 100 is capable of monitoring the occurrence of different types of events concurrently using the method 500. In this case, several instances of steps 530-540 of the method 500 are performed in parallel by the monitoring device 100, to monitor the different types of events concurrently. A subset of the sensor data collected at step 520 are used by each instance of steps 530-540. More specifically, each instance of steps 530-540 uses its own subset of sensor data as inputs of its neural network 113. Furthermore, a dedicated predictive model is used for each instance of steps 530-540. Each dedicated predictive model is adapted to detect occurrence of the event monitored by each corresponding instance of steps 530-540.

The terminology event shall be interpreted broadly, as generally referring to a single event (e.g. a fall of the person, a getting up of the person after a fall, a sitting of the person on a bed or in an armchair, a getting up of the person from the bed or the armchair, etc.). In this case, the predictive model of the neural network 113 is trained to detect occurrence of the single event based on the sequence of sensor data collected during the occurrence of the single event. Alternatively, the event refers to a chain of sub-events constituting an event to monitor (e.g. a fall followed by a getting up). In this case, the predictive model of the neural network 113 is trained to detect occurrence of the entire chain of sub-events constituting the event based on the sequence of sensor data collected during occurrence of the entire chain of sub-events. The decision to handle a chain of two or more sub-events as individual sub-events (having respective corresponding predictive models) or as a global event encompassing the chain of sub-events (using a single global predictive model) is usually taken after experimentations allowing to determine which of the two options provides better results in terms of detection with the neural network 113.

### Person Detection

Reference is now made to FIGS. 6A-C. Following is a description of an iterative approach in order to tune the detection layer of the radar sensor 200 to specifically detect persons, and to differentiate persons from other living or moving candidates (e.g. animals, furniture, devices, etc.). The tuning consists in adjusting several configuration parameters of the radar sensor 200, which define how the detection layer of the radar sensor 200 operates. To assess if a point cloud (comprising N points) generated by the radar sensor 200 matches a person, the point cloud is evaluated with at least some of the following criteria: person size (with respect to the coordinate axes X, Y and Z), distribution of the points (with respect to the coordinate axes X, Y and Z), standard deviation of the points (with respect to the coordinate axes X, Y and Z), number of points over distance, mean SNR of the point, person creation at maximum distance, tracking, reflections, etc.

The iterative process to determine an optimal configuration of the radar sensor 200 in order to detect persons is as follows. A candidate configuration of the radar sensor 200 is determined and enforced (several configuration parameters of the radar sensor 200 are set to respective candidate values). The point cloud representative of the person generated by the radar sensor 200 corresponding to a person configuration is recorded along with the corresponding candidate configuration. The point cloud is evaluated with respect to the previously mentioned criteria (using at least one of computational analysis, statistical analysis, comparison tools, evaluation of a graphical representation of the point cloud. etc.). If the candidate configuration provides better detection and candidate creation based on the evaluation (by comparison to a reference configuration), the candidate configuration is kept and becomes the new reference configuration, otherwise it is dismissed. The iterative process continues with a new candidate configuration, until a reference configuration is determined to be satisfying.

In addition to the aforementioned evaluation criteria, parameters of the configuration file of the radar sensor 200 are tuned to optimize the person detection at a specific range (e.g. 3, 5, 7 and 10 meters). The tuning provides a better representation of the person based on the environment and may help reducing the creation of reflective shadows (false persons).

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A monitoring device comprising:
memory storing a predictive model of a neural network, the predictive model comprising weights of the neural network; and
a processing unit comprising one or more processor configured to:
receive sensor data representative of a person, the sensor data being generated by a radar sensor, the sensor data comprising at least one of the following: a plurality of consecutive sets of centroid data representative of the person and a plurality of consecutive sets of point cloud data representative of the person; and
execute a neural network inference engine, the neural network inference engine implementing the neural network using the predictive model for inferring one or more output based on inputs, the one or more output providing an indication of whether an event related to the person has occurred or not, the inputs comprising at least some of the sensor data.

2. The monitoring device of claim 1, wherein the radar sensor is integrated to the monitoring device.

3. The monitoring device of claim 1, wherein the radar sensor is not integrated to the monitoring device, and the sensor data are received from the radar sensor via a communication interface of the monitoring device.

4. The monitoring device of claim 1, wherein the inputs comprise the plurality of consecutive sets of centroid data representative of the person, each set of centroid data comprising at least one of the following: at least one coordinate of the centroid, at least one velocity component of the centroid, and at least one acceleration component of the centroid.

5. The monitoring device of claim 1, wherein the inputs comprise the plurality of consecutive sets of point cloud data representative of the person, each set of point cloud data comprising for each point of the point cloud at least one of the following: at least one coordinate of the point, a velocity of the point, and a signal to noise ratio (SNR) of the point.

6. The monitoring device of claim 1, wherein the inputs further comprise at least one of the following: contextual information related to the person, contextual information related to an environment where the person is located, timing information and static coordinate data related to the environment where the person is located.

7. The monitoring device of claim 1, wherein the one or more output providing an indication of whether an event related to the person has occurred or not comprises at least one of the following: a Boolean and a probability, the one or more output optionally further comprising an indication of severity of the event.

8. The monitoring device of claim 7, wherein the one or more output further comprises an indication of severity of the event.

9. The monitoring device of claim 1, wherein the person is located in a room at least partially in a field of view of the radar sensor, and the event is a fall of the person.

10. The monitoring device of claim 1, wherein the one or more output is indicative of the event related to the person having occurred, and the monitoring device performs at least one of the following actions: sending via a communication interface of the monitoring device an alert message indicative of the event related to the person having occurred to a remote computing device and triggering a display of a visual indicator representative of the detection that the event related to the person has occurred.

11. The monitoring device of claim 10, wherein the monitoring device sends the alert message indicative of the event related to the person having occurred to the remote computing device, the alert message comprising at least one of the following: a location where the event related to the person has occurred, the plurality of consecutive sets of centroid data representative of the person and the plurality of consecutive sets of point cloud data representative of the person.

12. A method for monitoring a person based on radar sensor data, the method comprising:
storing in a memory of a computing device a predictive model of a neural network, the predictive model comprising weights of the neural network;
collecting by a processing unit of the computing device sensor data generated by a radar sensor, the sensor data being representative of the person, the sensor data comprising at least one of the following: a plurality of consecutive sets of centroid data representative of the person and a plurality of consecutive sets of point cloud data representative of the person; and
executing by the processing unit of the computing device a neural network inference engine, the neural network inference engine implementing the neural network using the predictive model for inferring one or more output based on inputs, the one or more output providing an indication of whether an event related to the person has occurred or not, the inputs comprising at least some of the sensor data.

13. The method of claim 12, wherein the inputs comprise the plurality of consecutive sets of centroid data representative of the person, each set of centroid data comprising at least one of the following: at least one coordinate of the centroid, at least one velocity component of the centroid, and at least one acceleration component of the centroid.

14. The method of claim 12, wherein the inputs comprise the plurality of consecutive sets of point cloud data representative of the person, each set of point cloud data comprising for each point of the point cloud at least one of the following: at least one coordinate of the point, a velocity of the point, and a signal to noise ratio (SNR) of the point.

15. The method of claim 12, wherein the inputs further comprise at least one of the following: contextual information related to the person, contextual information related to an environment where the person is located, timing information and static coordinate data related to the environment where the person is located.

16. The method of claim 12, wherein the one or more output providing an indication of whether an event related to the person has occurred or not comprises at least one of the following: a Boolean and a probability, the one or more output optionally further comprising an indication of severity of the event.

17. The method of claim 16, wherein the one or more output further comprises an indication of severity of the event.

18. The method of claim 12, wherein the person is located in a room at least partially in a field of view of the radar sensor, and the event is a fall of the person.

19. The method of claim 12, wherein the one or more output is indicative of the event related to the person having occurred, and the method further comprises at least one of following: sending an alert message indicative of the event related to the person having occurred to a remote computing device and triggering a display of a visual indicator representative of the detection that the event related to the person has occurred.

20. The method of claim 19, wherein the method further comprises sending the alert message indicative of the event related to the person having occurred to the remote computing device, the alert message comprising at least one of the following: a location where the event related to the person has occurred, the plurality of consecutive sets of centroid data representative of the person and the plurality of consecutive sets of point cloud data representative of the person.
